(19) United States
(12) Patent Application Publication
(10) Pub. No.: US 2026/0367718 A1
(43) Pub. Date: Nov. 19, 2026

(54) PEN-TYPE INPUT DEVICE

(71) Applicant: EMRIGHT TECHNOLOGY CO., LTD., Hsinchu County (TW)

(72) Inventor: Chien-Te Lee, Hsinchu County (TW)

(73) Assignee: EMRIGHT TECHNOLOGY CO., LTD., Hsinchu County (TW)

(21) Appl. No.: 19/553,414

(22) Filed: Mar. 1, 2026

(30) Foreign Application Priority Data
May 19, 2025 (TW) 114118688

(51) Int. Cl. G06F 3/0354

(52) U.S. Cl. CPC G06F 3/03546

(57) ABSTRACT

A pen-type input device includes a pen tip housing, a porous structure, a cushion member, a plurality of balls and a spherical body. The porous structure is disposed within the pen tip housing. The porous structure has a plurality of first holes. The cushion member is disposed within the pen tip housing and abuts against a first side of the porous structure. The plurality of balls are disposed within the pen tip housing and abut against a second side of the porous structure, wherein the first side and the second side are opposite to each other. The spherical body abuts against the plurality of balls and partially protrudes from the pen tip housing.

### BACKGROUND OF THE INVENTION

### 1. Field of The Invention

The invention relates to a pen-type input device and, more particularly, to a pen-type input device capable of reducing frictional loss and noise.

### 2. Description of The Prior Art

A stylus or digital pen is a pen-type input device used to input commands into an electronic device with a touch panel, such as computer screen, mobile device, drawing tablet and so on. Alternatively, the movement trajectory of the pen-type input device may be determined by optical blocking, thereby inputting commands into the electronic device. However, during operation, the pen-type input device is in contact with and rubs against the touch panel, which makes the pen tip prone to wear. Furthermore, the pen tip of the pen-type input device may also generate annoying noise when touching or writing on the touch panel.

### SUMMARY OF THE INVENTION

The invention provides a pen-type input device capable of reducing frictional loss and noise, so as to solve the aforesaid problems.

According to an embodiment of the invention, a pen-type input device comprises a pen tip housing, a porous structure, a cushion member, a plurality of balls and a spherical body. The porous structure is disposed within the pen tip housing. The porous structure has a plurality of first holes. The cushion member is disposed within the pen tip housing and abuts against a first side of the porous structure. The plurality of balls are disposed within the pen tip housing and abut against a second side of the porous structure. The first side and the second side are opposite to each other. The spherical body abuts against the plurality of balls and partially protrudes from the pen tip housing.

As mentioned in the above, the spherical body protruding from the pen tip housing forms point contact with the balls. When the pen-type input device performs touch operation on a touch panel through the spherical body, the spherical body will roll due to the action of the balls, such that the spherical body will not directly rub against the touch panel. Accordingly, the invention can significantly reduce frictional loss on the spherical body, thereby extending the service life of the pen-type input device. Furthermore, when the spherical body is pressed during touch operation, the cushion member can provide a cushioning effect, which can reduce the transmission of noise when the spherical body is in contact with the touch panel. Moreover, the porous structure can offset the noise generated by the spherical body during touch operation, so as to further reduce noise.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a pen-type input device according to an embodiment of the invention.

FIG. 2 is a partial exploded view illustrating the pen-type input device shown in FIG. 1.

FIG. 3 is a partial sectional view illustrating the pen-type input device shown in FIG. 1.

FIG. 4 is a front view illustrating a porous structure shown in FIG. 3.

FIG. 5 is a front view illustrating a porous structure according to another embodiment of the invention.

FIG. 6 is a front view illustrating a porous structure according to another embodiment of the invention.

### DETAILED DESCRIPTION

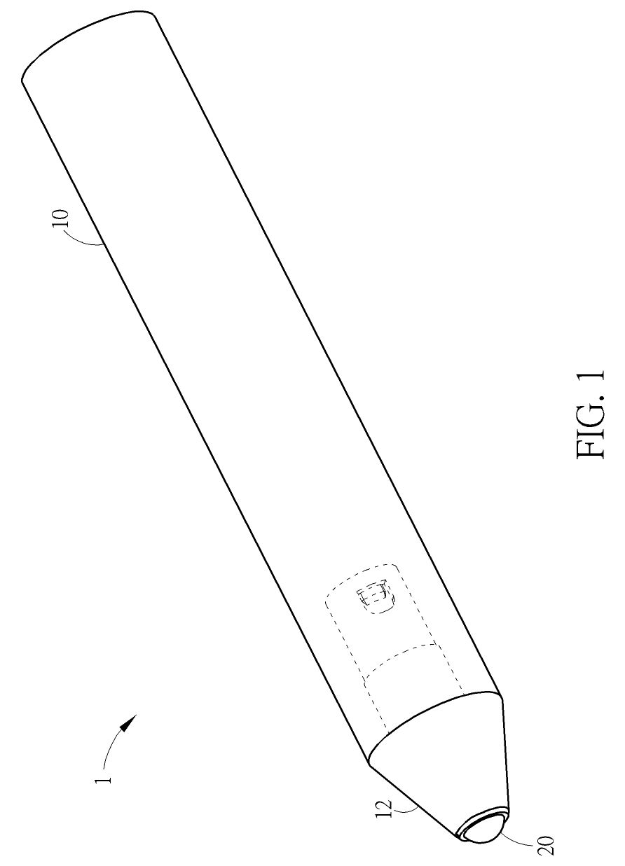

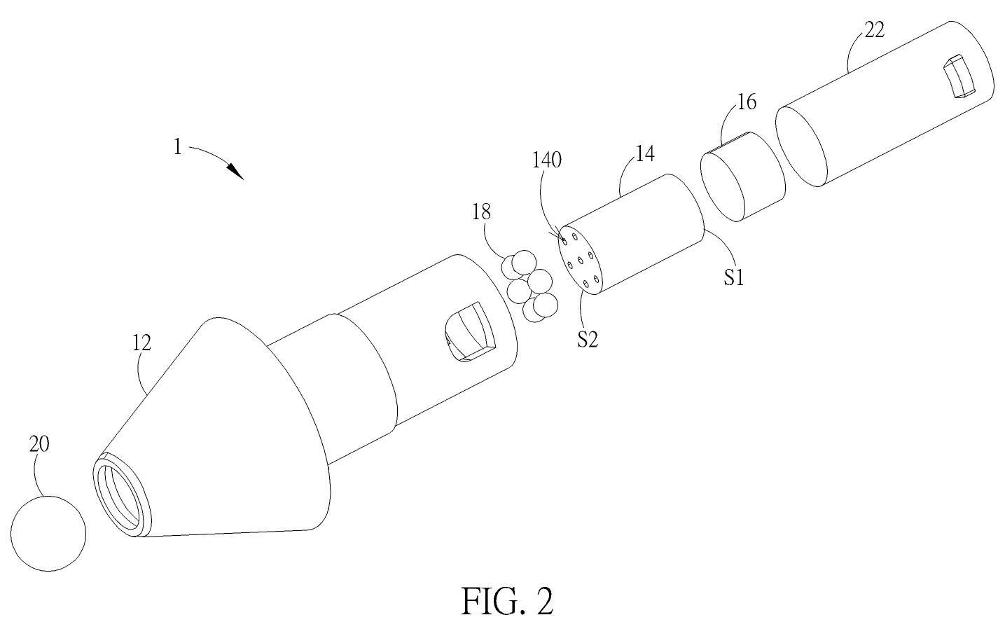

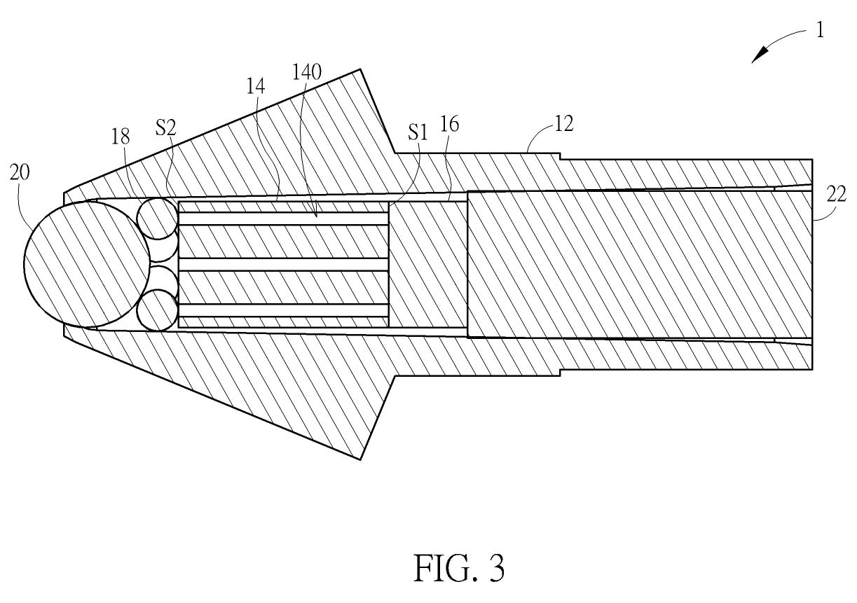

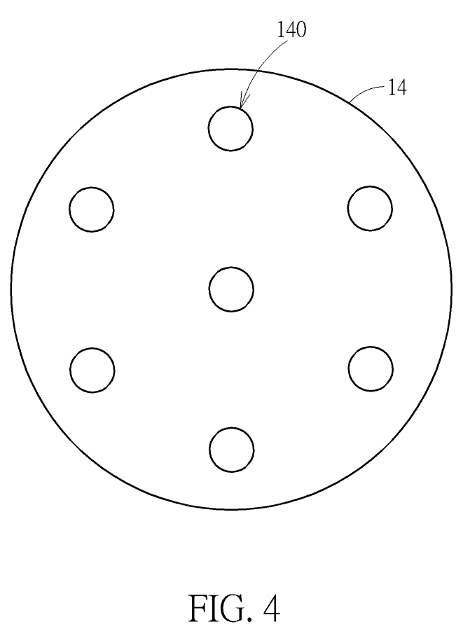

Referring to FIGS. 1 - 4, FIG. 1 is a perspective view illustrating a pen-type input device 1 according to an embodiment of the invention, FIG. 2 is a partial exploded view illustrating the pen-type input device 1 shown in FIG. 1, FIG. 3 is a partial sectional view illustrating the pen-type input device 1 shown in FIG. 1, and FIG. 4 is a front view illustrating a porous structure 14 shown in FIG. 3.

As shown in FIGS. 1 and 2, the pen-type input device 1 comprises a pen body 10, a pen tip housing 12, a porous structure 14, a cushion member 16, a plurality of balls 18, a spherical body 20 and a restraining member 22. The pen-type input device 1 may be a stylus, a digital pen or the like according to practical applications. The pen tip housing 12 is mounted on one end of the pen body 10 and the spherical body 20 protrudes from the pen tip housing 12. A user may hold the pen body 10 and perform touch operation on a touch panel (not shown) through the spherical body 20.

The porous structure 14, the cushion member 16, the plurality of balls 18 and the restraining member 22 are disposed within the pen tip housing 12. The cushion member 16 abuts against a first side S1 of the porous structure 14 and the plurality of balls 18 abut against a second side S2 of the porous structure 14, wherein the first side S1 and the second side S2 are opposite to each other and located at opposite sides of the porous structure 14. The spherical body 20 abuts against the plurality of balls 18 and partially protrudes from the pen tip housing 12. The restraining member 22 abuts against the cushion member 16 to restrain the cushion member 16, the porous structure 14, the balls 18 and the spherical body 20 within the pen tip housing 12. The materials of the porous structure 14 and the restraining member 22 may be plastic, the material of the cushion member 16 may be rubber, the material of the spherical body 20 may be rubber or polyoxymethylene (POM), the balls 18 may be steel balls, but the invention is not so limited. The number of the balls 18 may be determined according to practical applications, so the invention is not limited to the embodiment shown in the figure. For example, when a diameter of the spherical body 20 is 3 mm, at least three balls 18 may be disposed, and a maximum diameter of each ball 18 may be 1.39 mm.

As shown in FIG. 3, the spherical body 20 forms point contact with the balls 18. When the pen-type input device 1 performs touch operation on a touch panel through the spherical body 20, the spherical body 20 will roll due to the action of the balls 18, such that the spherical body 20 will not directly rub against the touch panel. Accordingly, the invention can significantly reduce frictional loss on the spherical body 20, thereby extending the service life of the pen-type input device 1. Furthermore, when the spherical body 20 is pressed during touch operation, the cushion member 16 can provide a cushioning effect, which can reduce the transmission of noise when the spherical body 20 is in contact with the touch panel. In this embodiment, a hardness of the spherical body 20 may be larger than a hardness of the cushion member 16, so as to effectively reduce the transmission of noise. Taking Shore A hardness as an example, the hardness of the spherical body 20 may be Shore A 80 and the hardness of the cushion member 16 may be Shore A 30, but the invention is not so limited.

As shown in FIGS. 2-4, the porous structure 14 has a plurality of first holes 140, wherein the plurality of first holes 140 penetrate the first side S1 and the second side S2 of the porous structure 14. The number and arrangement of the first holes may be determined according to practical applications, so the invention is not limited to the embodiment shown in the figure. When the pen-type input device 1 performs touch operation on a touch panel through the spherical body 20, the first holes 140 of the porous structure 14 can offset the noise generated by the spherical body 20 during touch operation, so as to further reduce noise. In an embodiment, a diameter of each of the first holes 140 may be smaller than 1 mm to be used to offset high-frequency noise. In an embodiment, a diameter of each of the first holes 140 may be between 1 mm and 5 mm to be used to offset low-frequency to mid-frequency noise.

In this embodiment, a diameter of each of the balls 18 may be larger than a diameter of each of the first holes 140 to prevent the ball 18 from getting embedded in the first hole 140. It should be noted that when the positions of the balls 18 are misaligned with the positions of the first holes 140, the ball 18 will not get embedded in the first hole 140. At this time, the diameter of each of the balls 18 may be smaller than or equal to the diameter of each of the first holes 140.

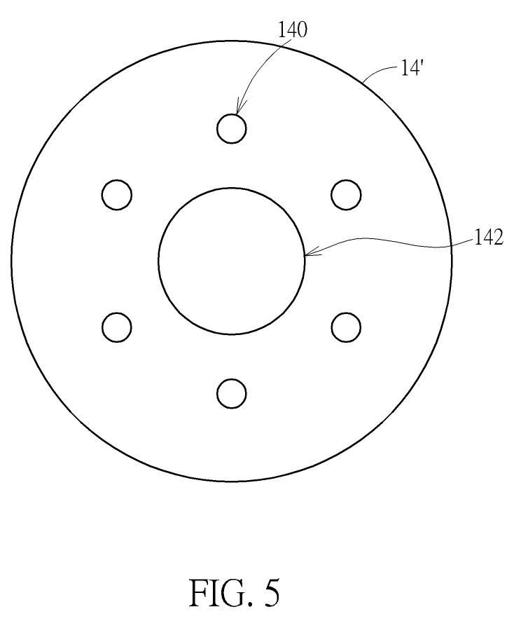

Referring to FIG. 5, FIG. 5 is a front view illustrating a porous structure 14' according to another embodiment of the invention.

The main difference between the porous structure 14' and the aforesaid porous structure 14 is that the porous structure 14' further has at least one second hole 142, as shown in FIG. 5. In this embodiment, a diameter of the at least one second hole 142 is larger than a diameter of each of the first holes 140, and the first holes 140 may be arranged around the at least one second hole 142. It should be noted that the number and arrangement of the first holes 140 and the second holes 142 may be determined according to practical applications, so the invention is not limited to the embodiment shown in the figure. In this embodiment, a diameter of each of the first holes 140 may be smaller than 1 mm to be used to offset high-frequency noise, and a diameter of the second hole 142 may be between 1 mm and 5 mm to be used to offset low-frequency to mid-frequency noise. The porous structure 14 shown in FIGS. 2 and 3 may be replaced by the porous structure 14' shown in FIG. 5. Since the second hole 142 is located at the center of the porous structure 14', the ball 18 will not get embedded in the second hole 142 even if the diameter of the ball 18 is smaller than or equal to the diameter of the second hole 142. Needless to say, the diameter of the ball 18 may also be larger the diameter of the second hole 142 according to practical applications.

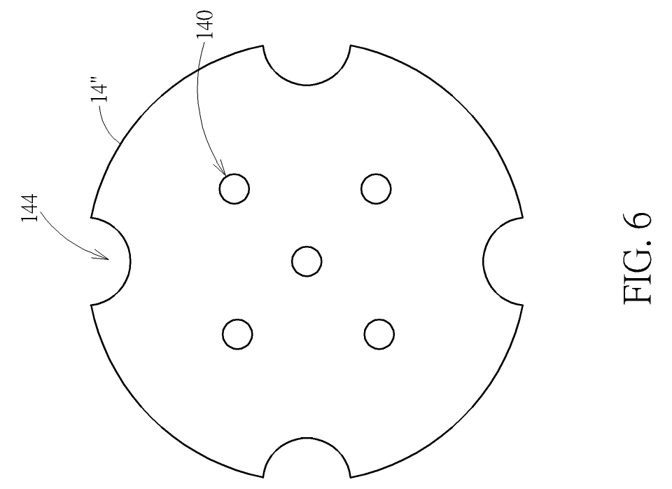

Referring to FIG. 6, FIG. 6 is a front view illustrating a porous structure 14'' according to another embodiment of the invention.

The main difference between the porous structure 14'' and the aforesaid porous structure 14 is that the porous structure 14'' further has a plurality of grooves 144, as shown in FIG. 6. In this embodiment, the plurality of grooves 144 may be formed on an outer periphery of the porous structure 14'', and a maximum width of each of the grooves 144 is larger than a diameter of each of the first holes 140. It should be noted that the number and arrangement of the first holes 140 and the grooves 144 may be determined according to practical applications, so the invention is not limited to the embodiment shown in the figure. In this embodiment, a diameter of each of the first holes 140 may be smaller than 1 mm to be used to offset high-frequency noise, and a maximum width of each of the grooves 144 may be between 1 mm and 5 mm to be used to offset low-frequency to mid-frequency noise. The porous structure 14 shown in FIGS. 2 and 3 may be replaced by the porous structure 14'' shown in FIG. 6. Since the grooves 144 are formed on the outer periphery of the porous structure 14'', the diameter of the ball 18 needs to be larger than the maximum width of the groove 144, so as to prevent the ball 18 from getting embedded in the groove 144.

As mentioned in the above, the spherical body protruding from the pen tip housing forms point contact with the balls. When the pen-type input device performs touch operation on a touch panel through the spherical body, the spherical body will roll due to the action of the balls, such that the spherical body will not rub directly against the touch panel. Accordingly, the invention can significantly reduce frictional loss on the spherical body, thereby extending the service life of the pen-type input device. Furthermore, when the spherical body is pressed during touch operation, the cushion member can provide a cushioning effect, which can reduce the transmission of noise when the spherical body is in contact with the touch panel. Moreover, the porous structure can offset the noise generated by the spherical body during touch operation, so as to further reduce noise.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pen-type input device comprising:
a pen tip housing;
a porous structure disposed within the pen tip housing, the porous structure having a plurality of first holes;
a cushion member disposed within the pen tip housing and abutting against a first side of the porous structure;
a plurality of balls disposed within the pen tip housing and abutting against a second side of the porous structure, the first side and the second side being opposite to each other; and
a spherical body abutting against the plurality of balls and partially protruding from the pen tip housing.

2. The pen-type input device of claim 1, wherein a diameter of each of the plurality of balls is larger than a diameter of each of the plurality of first holes.

3. The pen-type input device of claim 1, wherein the porous structure further has at least one second hole, and a diameter of the at least one second hole is larger than a diameter of each of the plurality of first holes.

4. The pen-type input device of claim 3, wherein the plurality of first holes are arranged around the at least one second hole.

5. The pen-type input device of claim 1, wherein the porous structure further has a plurality of grooves formed on an outer periphery of the porous structure, and a maximum width of each of the plurality of grooves is larger than a diameter of each of the plurality of first holes.

6. The pen-type input device of claim 5, wherein a diameter of each of the plurality of balls is larger than the maximum width of each of the plurality of grooves.

7. The pen-type input device of claim 1, wherein a hardness of the spherical body is larger than a hardness of the cushion member.
